(19) United States
(12) Patent Application Publication
(10) Pub. No.: US 2022/0305378 A1
(43) Pub. Date: Sep. 29, 2022

(54) RFID-ENABLED PHYSICALLY MANUFACTURED FIGURINES

(71) Applicant: Integral Reality Labs, Inc., San Francisco, CA (US)

(72) Inventors: James Ward, Phoenix, AZ (US); Zuhair Abdul Hadi, Dublin, CA (US); John Vifian, Pleasanton, CA (US); Kyle Kinkade, Newport Beach, CA (US); Gilman Louie, San Francisco, CA (US); Joseph E. Scott, Palo Alto, CA (US); Jason Clyde, Daly City, CA (US); Sherman Meredith, Foster City, CA (US)

(21) Appl. No.: 17/702,528

(22) Filed: Mar. 23, 2022

Related U.S. Application Data
(60) Provisional application No. 63/200,735, filed on Mar. 25, 2021.

(51) Int. Cl. A63F 13/24; G06T 19/20; G06K 19/07; G06K 7/10; A63F 13/65; B33Y 80/00; B33Y 50/00; B29C 64/386

(52) U.S. Cl. CPC A63F 13/24; G06T 19/20; G06K 19/0723; G06K 7/10366; A63F 13/65; B33Y 80/00; B33Y 50/00; B29C 64/386; G06T 2219/2012; G06T 2219/2021; B29L 2031/52

(57) ABSTRACT

A user can create and customize a digital character, for instance an avatar, a playable video game character, or a rendering of a character. The user can likewise define characteristics of the character, including a physical appearance of the character, statistics associated with the character, accessories of the character, and the like. The digital character can be manufactured, producing a physical figurine, which can include an RFID device. An NFT can be generated based on the digital character, for based on one or more characteristics of the character, the user, or any other factor. The NFT can be associated with the figurine, with the user, with a user account of the user, with an identifier associated with the RFID device, and with the digital character. The figurine can be used to unlock one or more features of a gaming system, a game, an entertainment platform, or any other system.

### CROSS REFERENCE TO RELATED APPLICATIONS

This application claims the benefit of U.S. Provisional Application Ser. No. 63/200,735 filed Mar. 25, 2021, which is incorporated in its entirety herein by this reference.

### TECHNICAL FIELD

This disclosure relates to manufacturing, and in particular to the manufacture of RFID-enabled figurines associated with NFTs.

### BACKGROUND

In some games, a character may have attributes that impact gameplay and evolve over time. For example, a particular character may have a skill, a power, an item, or “knowledge” that is modified through gameplay. In some games, such character attributes may persist between multiple gameplay sessions. A character may manifest can be displayed as a digital representation of the character within a game, which can include a graphical representation of the character, animations associated with the character, sounds associated with the character, and meta-data such as character attributes. Additionally, in some game systems, a user may use a physical game-piece that is representative of a character in order to interact with the game. Such interactions may include a character movement, a character placement, or triggering an event associated with the character.

### BRIEF DESCRIPTION OF THE DRAWINGS

FIG. 1A is a perspective view of a gaming device, in accordance with some embodiments.

FIG. 1B is a cross-section view of the gaming device shown in FIG. 1A, in accordance with some embodiments.

FIGS. 2A-2C are example user interfaces for generating RFID-enabled physically manufactured characters, in accordance with some embodiments.

FIG. 3 illustrates an example of an RFID-enabled physically manufactured character, in accordance with some embodiments.

FIG. 4 illustrates an example of the RFID-enabled physically manufactured character shown in FIG. 3 interacting with the gaming device shown in FIG. 1A, in accordance with some embodiments.

FIGS. 5A-5E are flow charts illustrates portions of a process for generating an RFID-enabled physically manufactured character, in accordance with some embodiments.

FIG. 6 is a diagram of an example computing system of the gaming device shown in FIG. 1A, in accordance with some embodiments.

### DETAILED DESCRIPTION

In some games, a character may have attributes that impact gameplay and evolve over time. Such attributes may be associated with a digital representation of the character and may also be associated with user account information. Additionally, in some games, a user may use a physical game piece that is representative of the character. In games that allow the use of user-created characters (e.g., role-playing games), a user may desire to use a physical game piece that is similar in appearance to a digital representation of that character. However, in games that allow a user to customize the appearance of the digital representation of the character, a mass-manufactured game piece will likely not correspond in appearance to the customized appearance of the digital representation of that character.

As disclosed herein, an RFID-enabled physically manufactured character (e.g., a figurine, game piece, collectible, or any other suitable object) may be manufactured based on a customized digital representation of a character created by a user. As described below, the user may customize the character using one or more character creation tools, specifying various characteristics of the character's physical appearance, including the character's height, width, or other dimensions; species; accessories; items associated with the character (such as a held weapon or worn armor); color; stance or pose; and the like. The customized digital representation of the character can be manufactured to produce a physical figurine such that the appearance of the physical figurine closely or exactly matches that of the digital representation of the character.

Additionally, the RFID-enabled physically manufactured character advantageously provides a link between 1) the physically manufactured character, 2) the digital representation of the user-created character, 3) a unique identifier associated with the physically manufactured character (e.g., an ID associated with an RFID device embedded within the physically manufactured character), 4) user account information or other user characteristics associated with the character, and/or 5) an NFT generated based on the digital representation of the character or the physically manufactured character. As a result of this linkage, attributes of the user-created character, the digital representation of the user-created character, and other aspects associated with the user account are advantageously made available during gameplay upon detection of the RFID-enabled physically manufactured character by a gaming system within a proximity of the character. As discussed below, the NFT can be modified over time, for instance to reflect progress made during gameplay by a digital character, to reflect changes or modifications to the digital character, to reflect updates to user account information, and the like.

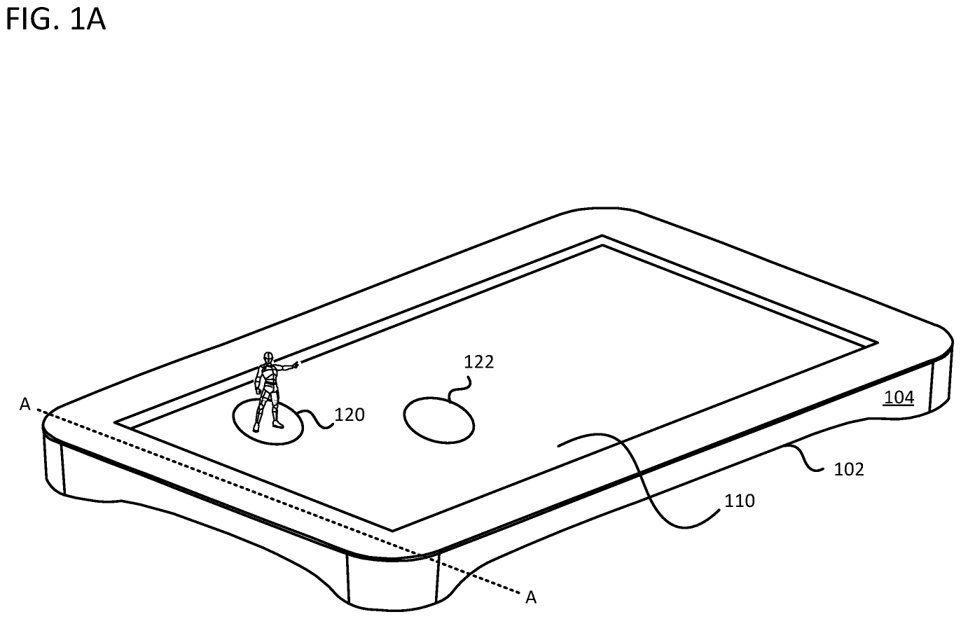

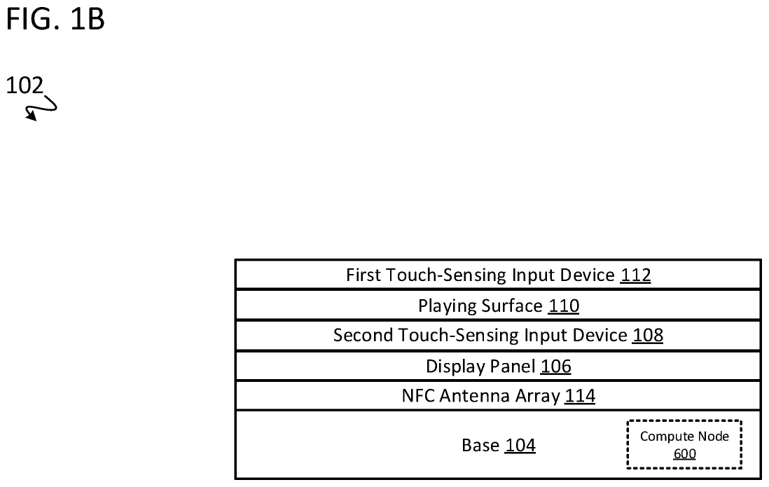

FIG. 1A depicts a gaming device 102, in accordance with some embodiments. As shown in FIG. 1A, the gaming device 102 includes a base portion 104 and a playing surface 110. In the example shown, physical game elements 120 (e.g., tokens, game-pieces, scenery items, avatars, cards, etc.) are placed by a user on the playing surface 110. Additionally, graphical objects 122 (e.g., still images, animations, video, text, etc.) are displayed by a video panel (shown in FIG. 1B) to facilitate gameplay or other user interactions with the gaming device 102. Also shown is a cross-section indicator A-A. In some embodiments, one or more of the physical game elements include a radio frequency identification (RFID) device (e.g., an RFID tag) having a passive or active data store, such as a memory module, that can be read to and/or written to via a near-field communication (NFC) antenna using NFC communication protocols that are known in the art. It should be noted that although FIG. 1A depicts a surface gaming system, in practice, the principles described herein apply equally to any type of gaming or computing system (such as a video game console, a smart phone, a computer, and the like).

FIG. 1B shows a cross-section A-A of the gaming device 102 shown in FIG. 1A, in accordance with some embodiments. In some embodiments, the cross-section A-A of the gaming device 102 includes a first touch-sensing input device 112, a transparent playing surface 110, a second touch-sensing input device 108, a display panel 106, an NFC antenna array 114, the base portion 104, and a compute node 600 of the base portion 104.

In some embodiments, the first touch-sensing input device 112 is a capacitive, resistive, or infrared touch-sensing interface that is parallel to the playing surface 110 and is configured to receive individual, sequenced, and/or simultaneous first touch inputs (e.g., from a user's finger or a game piece). The compute node 600 of the base portion 104 is configured to receive the first touch inputs and to determine corresponding first two-dimensional touch positions in a plane parallel to the playing surface 110.

In some embodiments, the playing surface 110 is a transparent protective layer on top of the second touch-sensing input device 108 and is configured to protect the second touch-sensing input device 108 and the display panel 106 from scratches, spills, and so on. Some embodiments of the gaming device 102 do not include an optional transparent protective layer on top of the second touch-sensing input device 108. In such embodiments, the playing surface 110 is, or is part of, the second touch-sensing input device 108.

In some embodiments, the second touch-sensing input device 108 is a capacitive, resistive, or infrared touch-sensing interface that is parallel to the playing surface 110 and is configured to receive individual, sequenced, and/or simultaneous second touch inputs (e.g., from a user's finger or a game piece). The compute node 600 of the base portion 104 is configured to receive the second touch inputs and to determine corresponding second two-dimensional touch positions in a plane parallel to the playing surface 110.

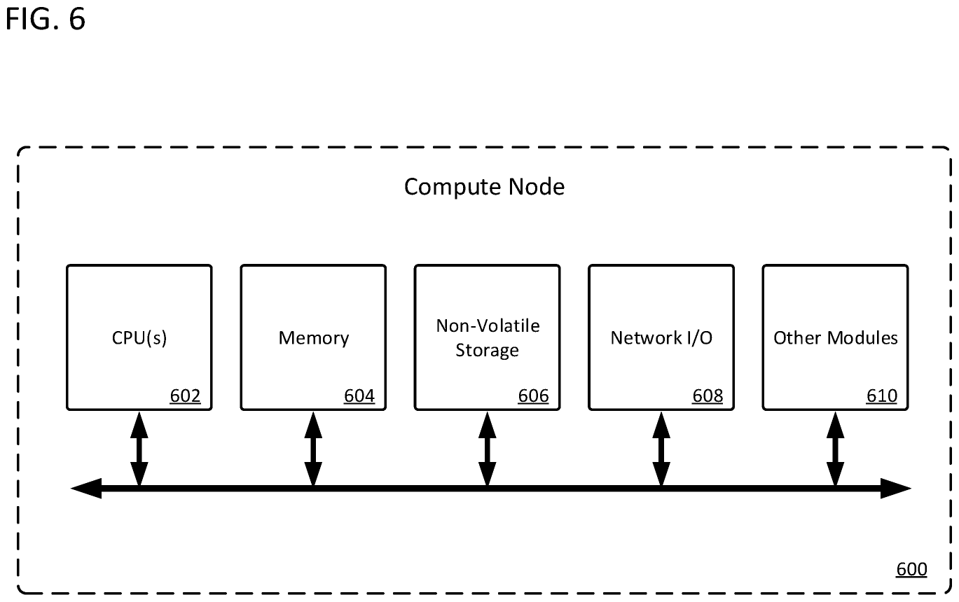

In some embodiments, the display panel 106 is coupled to, or is part of, the base portion 104 and is configured to display graphical objects that include still images, animations, video, or other graphical representations. In some embodiments, the base portion 104 includes one or more compute nodes that are the same, or similar to, the compute node 600 described with reference to FIG. 6.

The compute node 600 of the base portion 104 is configured to receive and transmit signals to NFC devices, such as RFID devices, that are proximate to the playing surface 110 using the NFC antenna array 114 (or any NFC enabled device). In some embodiments, the NFC antenna array 114 includes n NFC antennae, where n is a number sufficient for simultaneous communication with multiple NFC devices in multiple locations proximate to the playing surface 110 (e.g., n may be 1, 2, 16, 32, 128, 256, 512, etc.). In some embodiments, NFC antennae of the NFC antenna array 114 are partitioned into multiple zones in a plane parallel to the playing surface 110, and/or are located within other regions of the gaming device 102. It should be noted that in practice, the NFC antenna array 114 can be any device with NFC functionality, or with any communicative functionality, such as the transceivers within a mobile device.

Although a touch-screen gaming device is illustrated in the embodiments of FIGS. 1A and 1B, in practice, the principles described herein apply to any type of gaming device or computing system. For instance, a figurine manufactured to correspond to a customized digital character (or simply, “figurine” hereinafter) with an embedded RFID device (or, as described below, an equivalent ability to communicative information, such as a Bluetooth transceiver, a QR code, and the like) can interface with any type of gaming system or computing system. Examples of such gaming systems include but are not limited to the gaming consoles manufactured by Sony, Nintendo, and Microsoft; gaming computers (such as custom-built PCs or computers specifically sold as gaming machines); tablet computers; smart phones; smart televisions or monitors; or any other suitable computing system. Likewise, although gaming embodiments are described herein, the principles described herein apply equally to any digital experience, such as media applications, communication applications, online shopping, virtual reality applications, social gatherings (e.g., parties or other celebrations), public gatherings (e.g., concerts, movies, theater events, sporting events), any combination thereof, and the like.

In some embodiments, an identifier associated with a figurine (such as a unique identifier representative of the figurine, an RFID identifier, a user account identifier, an NFT, or the like) is communicated to a gaming device or computing system. For RFID-equipped figurines, the identifier associated with the figurine can be transmitted to the gaming device or computing system when the figurine is placed within a threshold distance (e.g., the communicative range of the RFID device within the figurine) of a gaming device or computing system. In such embodiments, the gaming device or computing system can receive the transmitted identifier via on onboard receiver or transceiver.

In other embodiments, the identifier can be communicated via another transmission medium, for instance an NFC standard other then RFID, Wifi, BlueTooth, or any other suitable format. In some embodiments, the figurine can include a QR code, bar code, or other scannable image or representation of the identifier. In such embodiments, the gaming device or computing system can capture of image of the figurine (for example, an image of a QR code imprinted on the figurine) to obtain the identifier. In yet other embodiments, the physical dimensions, shape, and appearance of the figurine can be used to determine the identifier. For instance, a figurine can be 3D scanned by a gaming device or computing system (or by a scanning peripheral accessory associated with the gaming device or computing system) to obtain the identifier (e.g., in the event that the identifier is computed based on physical characteristics of the figurine). For example, an NFT can be initially computed based on the precise dimensions of a digital character; in this example, the NFT can be determined by scanning (e.g., by a gaming device or computing system) a figurine manufactured based on the digital character to determine the dimensions of the figurine, and can be computed (e.g., by the gaming device or computing system) based on the determined dimensions of the figurine. It should be understood that when reference is made herein to RFID devices, any suitable mechanism, system, or method for the transfer of information from a figurine to a gaming device or computing system.

As discussed above, some games involve characters that have been customized by a user. In such games, a user may desire that the physical game element 120 is similar in appearance to a digital representation of the customized character (e.g., as displayed as one of the graphical objects 122).

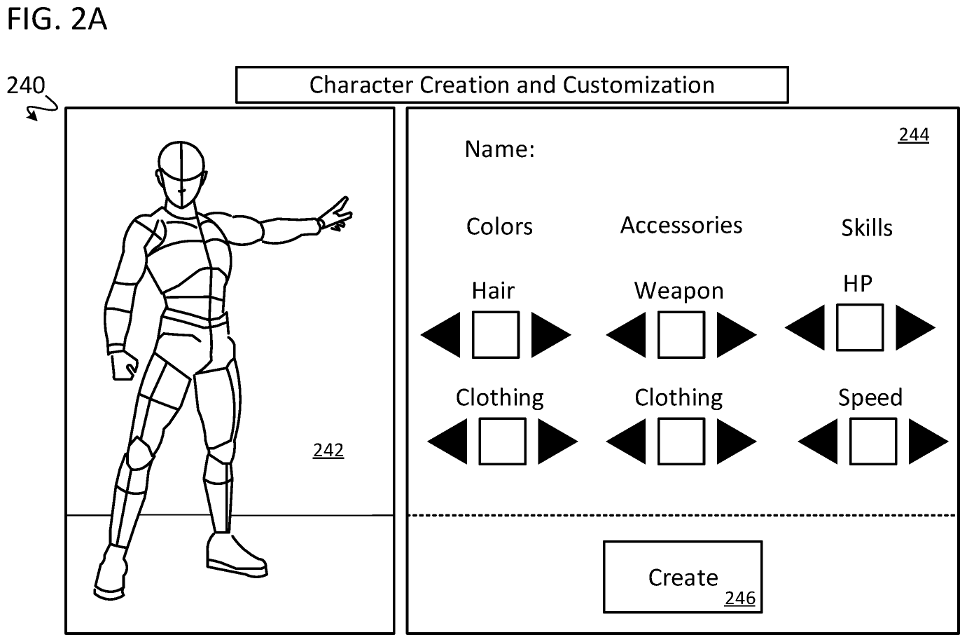

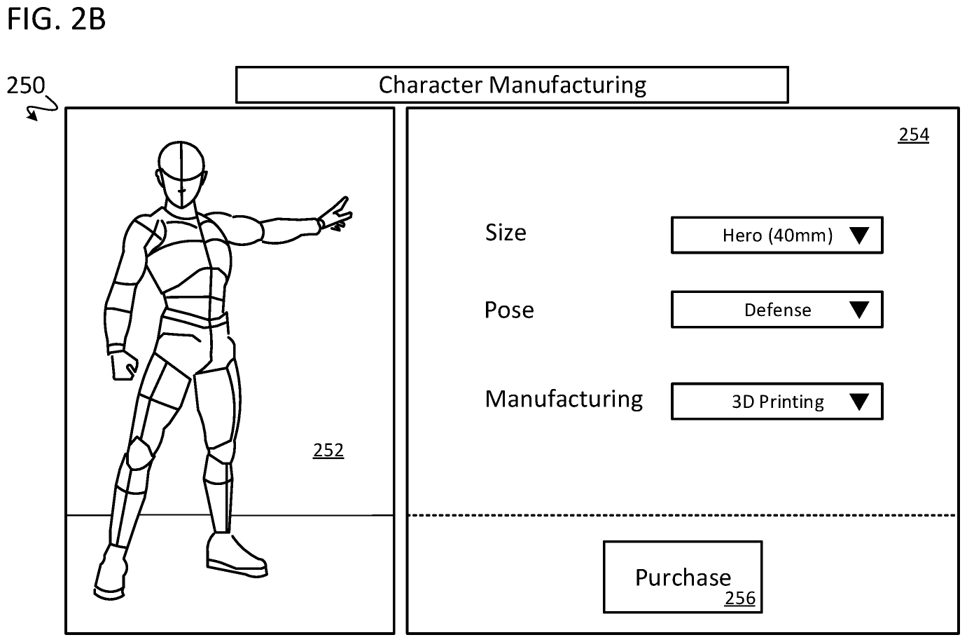

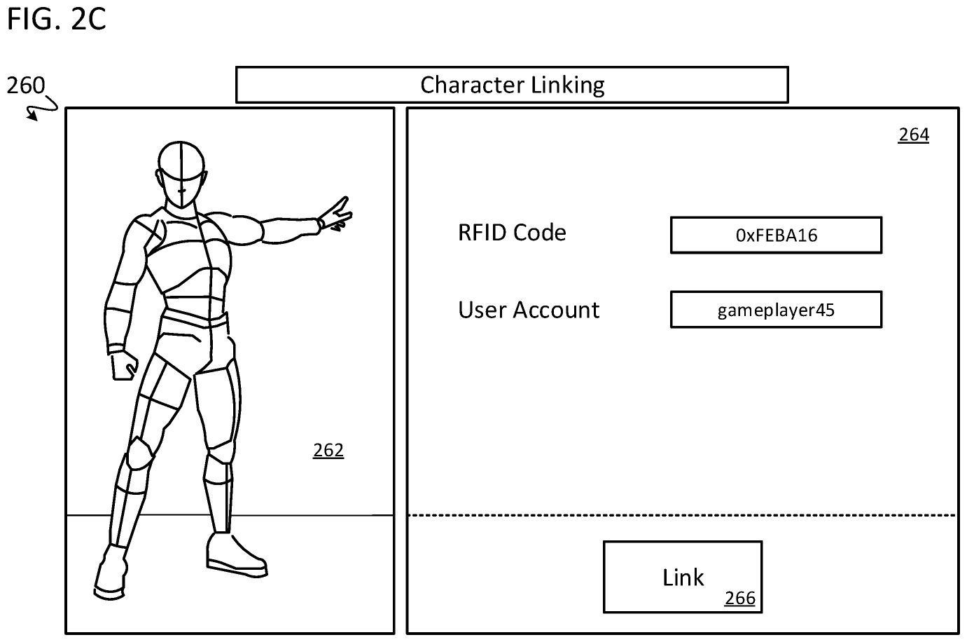

FIG. 2A shows an example user interface 240 for customizing a digital representation of a user-created character. The user interface 240 includes a visual digital representation 242 of the user-created character, a user interface 244 for setting attributes of the user-created character, and an interface 246 for finalizing a character customization process. Some non-limiting examples of attributes associated with a digital representation of a user-created character that can be modified by a user include character type, name, clothing, accessories, skills, specialties, associated game or games, associated peer characters, scale (e.g., tiny, infantry, hero, and boss), subclass, race, allegiance, career, gender, sex, dominant hand, age, eye color, skin color, weight (within scale), height (within scale), hair color, rune affinity, glyph affinity, tribe, cult, subcult, reputation, personality, and the like. As these attributes are adjusted via the interface 244, the appearance of the character within the interface 240 can correspondingly change, for instance in real-time or near real-time.

Once the user has customized the “naked physical” appearance of the user-created character itself, the user can then customize the user-created character's clothing, shoes, belt, jewelry, tattoos, weapon(s), armor by location, bag or pouch, pose, and other items of the character that are immutable within a game. Likewise, as these attributes are adjusted, the appearance of the character within the interface 240 can correspondingly change in real-time or near real-time. In some embodiments, a user can use the interface 244 to display an animation or motion of the character, for instance a jumping animation, swinging a sword, running, pulling and releasing an arrow, and the like. The interface 244 can be used to pause or slow the animation or motion of the character at a particular point in time, so that a user can pick a particular pose within the animation or motion of the character for use in the creation of the character. Likewise, a facial expression or other body language of the character can be customized using the interface 244.

After the user is finished customizing the appearance of the user-created character, the user may assign certain point values within the digital representation to different attributes of the character including, but not limited to, strength, constitution, dexterity, intelligence, power, charisma, fortitude, reflex, willpower, luck, sanity, hit points, speed, athletics, diplomacy, scholarship, perception, crafting, magic, defense, special defense, attack, special attack, husbandry, acrobatics, deception, history, insight, investigation, medicine, religion, nature, stealth, computers, survival, etc. Such point values may vary in type and range depending on a particular game that the character is associated with.

After the user is satisfied with a character's appearance and attributes, the user may then submit the character (e.g., using the create interface 246) for a dual process of digital non-fungible token (NFT) minting and physical manufacturing.

FIG. 2B shows an example user interface 250 for specifying characteristics of a figurine to be physically manufactured based on a user-created character. The user interface includes an example visual representation 252 of the character created and/or customized using the user interface 240, a user interface 254 for specifying physical manufacturing preferences, and an interface 256 for finalizing, saving, and/or submitting an order for physical manufacturing the user-created character. Some non-limiting examples of physical manufacturing preferences include physical size, character pose, material (e.g., plastic, metal, wood, stone, etc.), manufacturing method (e.g., 3D printing, injection molding, casting, milling, carving, etc.), hand-finishing, unpainted, factory-painted, hand-painted, and the like.

As a user customizes a character, one or more stats associated with a figurine corresponding to the character can be displayed. For instance, a user can specify a height of the figurine corresponding to the character, a weight of the figurine, one or more materials used in manufacturing the figurine, and the like, and these characteristics of the figurine can be displayed within the interface 250. For example, the text “6 inches tall, 235 grams” can be displayed under the representation of the character 252. As the user customizes the character and customizes characteristics of the figurine, a cost to manufacture the character can be displayed, for instance within the interface 250. For example, if a user initially specifies that the figurine should be 3 inches tall, the text “Cost to build: $15” can be displayed, and if the user later specifies that the figurine should be 6 inches tall, the displayed text can be changed to “Cost to build: $50”.

As described below, the physically manufactured character may include an RFID device that is contained on or within the character. The RFID device is used to advantageously link the physically manufactured character with a digital representation of the character, minted as a non-fungible token (NFT), and with user account information. FIG. 2C shows an example user interface 260 for linking (i.e., digitally or logically associating) an RFID code associated with a physically manufactured character, user account information, and the digital representation of the user-created character which has been minted as an NFT. In some embodiments, the minted NFT includes the digital representation of the user-created character. In other embodiments, the NFT includes the digital representation of the user-created character and all or a subset of the user account information.

In additional to including the digital representation of the user-created character and user account information, the NFTs described herein can be generated based on one or more of these types of information or other information. In some embodiments, the NFT is generated based on one or more characteristics of the customized digital character. For instance, values corresponding to one or more characteristics of the customized digital character (such as a species of the character, a name of the character, dimensions of the character, accessories corresponding to the character, and the like) are used as seed values for an NFT-generating algorithm. In some embodiments, the NFT is additionally generated based on one or more characteristics of the user or user account information (such as a user's name, the user's user name or gamer tag, recent user account activity, and the like).

As noted above, in some embodiments, an NFT can be generated by performing a 3D scan of the figurine to determine exact dimensions and shape of the figurine. These dimensions and shape can be represented by a numerical “fingerprint”, which can be used to seed an NFT-generating algorithm. Accordingly, the same NFT value can be computed both based on dimensions and shape of a digital character and based on a 3D scan of the dimensions and shape of a physical figurine, beneficially enabling a user to user the figurine as a “key” that provide access to the NFT (and thus to the digital character or user account associated with the NFT). Likewise, an NFT-generating algorithm can be seeded with numerical values representative of colors of the figurine, materials used to manufacture the figurine, letters or other symbols on the figuring, and the like.

In some embodiments, an NFT generated according to the principles described herein can be a single-use NFT, beneficially enabling ownership or possession of the NFT to be transferred between users until the NFT is used, for instance to unlock the digital character within a game, to unlock one or more game features, to unlock a game, or to unlock any other game mode or characteristic. For example, a user can create a customized digital character associated with a particular set of skills within a game. The user can manufacture the character to create a figurine, and the figurine can be associated with an NFT that, when used within a game, unlocks the digital character within the game. The figurine can be transferred to a second user's possession, and the second user can unlock the character within the game using the NFT. Even if the figurine later changes possession to a third user, the third user is unable to unlock the character within the game. In some embodiments, the second user, having unlocked the character within the game, can use the character within the game for all subsequent sessions of playing the game. In other embodiments, the character may be available to the second user only for a single playing session. In yet other embodiments, the character may be available to the user for all sessions of the game on a particular gaming device, but isn't available on other gaming systems. In yet other embodiments, the NFT can be used to authenticate a user in possession of the figurine, or to authenticate the figurine itself.

In some embodiments, an NFT generated according to the principles described herein can be a multi-use NFT, enabling any user in possession of the figurine to unlock one or more features of a game, for instance either permanently or while in possession of the figurine. Such embodiments beneficially encourage social gaming and sharing of figurines to increase the number of game features available to users. For instance, users can create digital characters, can request the manufacture of corresponding figurines, and can trade figurines after unlocking the corresponding characters within a game in order to increase the number of characters available to them within the game.

In some embodiments, the use of a figurine associated with an NFT within a game ecosystem can enable a user to transfer a digital character corresponding to the figurine between game systems for a same game, between games, between platforms, or between systems. In such embodiments, achievements of a digital character can likewise between transferred. For example, if a user unlocks a digital character associated with a figurine within a game (e.g., by placing an RFID-equipped figurine within a threshold proximity of a game system running the game), the user can play the game using the digital character, and can level the character up (e.g., from level 5 to level 6) during the course of playing the game. The stats and achievements of the digital character can be stored in association with the NFT associated with the digital character.

When the user then moves the figurine to within a threshold proximity of a second game system running the game, the second game system can detect an identifier associated with the figurine, can access the NFT associated with the identifier, and can access the stats and achievements of the digital character associated with the NFT. The user can then pick up playing the game on the second game system with the digital character where the user left off from playing on the first game system, with the stats and achievements obtained while playing on the first game system preserved (continuing with the previous example, the digital character can be played at level 6).

Accordingly, utilizing a physical figurine associated with an NFT enables a user to maintain persistent character stats and achievements across game systems and game play sessions. Further, the use of a physical figurine within the process of unlocking a digital character within a game improves the security of the digital character, requiring anyone attempting to unlock or access the digital character (or any game feature associated with a figurine) to be in physical possession of the figurine.

It should be noted that in addition to enabling a digital character to be transferred between game systems for the same game, the RFID-enabled figurines described herein can enable a digital character to be transferred between games. For instance, a user can unlock the digital character in an adventure game by placing a corresponding figurine within a proximity of a game system running the adventure game, and can increase the strength and speed stats of the digital character while playing the adventure game. The increased strength and speed stats are stored in associated with the NFT associated with the digital character and the figurine. The user can then load a fighting game on the game system, can place the figurine within a proximity of the game system, and can unlock the digital character on the fighting game. The game system can identify the NFT associated with the digital character, and can access the increased strength and speed stats stored in association with the NFT. The game system can then modify the digital character's abilities within the fighting game based on the accessed increased strength and speed stats. Likewise, an item obtained in a first game by the digital character can be stored in association with the NFT associated with the digital character, and can be accessed by the digital character when playing a second game. Such a system beneficially enables a user to realize benefits obtained in a first game within a second game. It some embodiments, an enter game itself is stored within a memory of the figurine, and the figurine, when placed within a proximity to a game system, can transfer the game to the game system, beneficially enabling a user to play the game (either permanently or while the figurine is in proximity to the game system).

An example user interface 264 provides fields for a user, such as a manufacturer, to enter an RFID code that will be associated with the user account information and the minted NFT. Also shown is a graphical digital representation 262 of the user-created character. The RFID code is an identifier read from or written to an RFID device attached to or embedded within the physically manufactured character. The digital representation includes a graphical representation of the user-created character, as well as character attributes, states, status, or other data associated with the user-created character. The user account information includes global account information associated with a user, account information for the user associated with a particular service (gaming, entertainment, or otherwise), a subset of user account information that is associated with a particular game, and/or a subset of user account information that is associated with only the user-created character. In some embodiments, the user account information includes a user name of the user, biographic or demographic characteristics of the user, gaming activity or history associated with the user, or any other information associated with the user.

In addition to the physical manufacturing of the user-created character, a digital non-fungible token (NFT) associated with the digital representation of the user-created character is minted (i.e., created). In some embodiments, to complete the order submission process, the user signs into a compatible account “wallet” or creates a compatible account wallet. The account wallet is created using blockchain technology, as is understood in the art. By completing the account wallet creation, a digital representation of the user-created character is captured and minted as an NFT that is immutable and tamper-proof. The user-created character NFT is stored on the blockchain and may be stored in a distributed file system, such as InterPlanetary File System (IPFS). The digital user-created character data associated with the NFT is sent to a manufacturer (e.g., a 3D printer, a mass manufacturer, or a hand-built manufacturing operation) that produces a true physical representation of the digital character according to the user-customized characteristics of the digital character. The physically manufactured character may additionally be painted, thereby bringing a true match of the digital representation of the user-created character to the physically manufactured character.

It should be noted that although the interfaces of FIGS. 2A-2C correspond to the customization of a digital character, in practice similar interfaces can be used to customize items, objects, collectibles, and the like. For instance, a digital baseball bat can be created, statistics and properties of the baseball bat can be specified, an appearance of the baseball bat can be customized, and a baseball bat figurine can be manufactured using interfaces similar to the interfaces of FIGS. 2A-2C. The baseball bat figurine can then be used to unlock a digital baseball bat within a baseball game. Likewise, a digital car can be created, properties and appearance of the digital car can be customized, and a car figurine can be manufactured using interfaces similar to the interfaces of FIGS. 2A-2C, and the car figurine can be used to unlock a corresponding digital car within a driving simulator application.

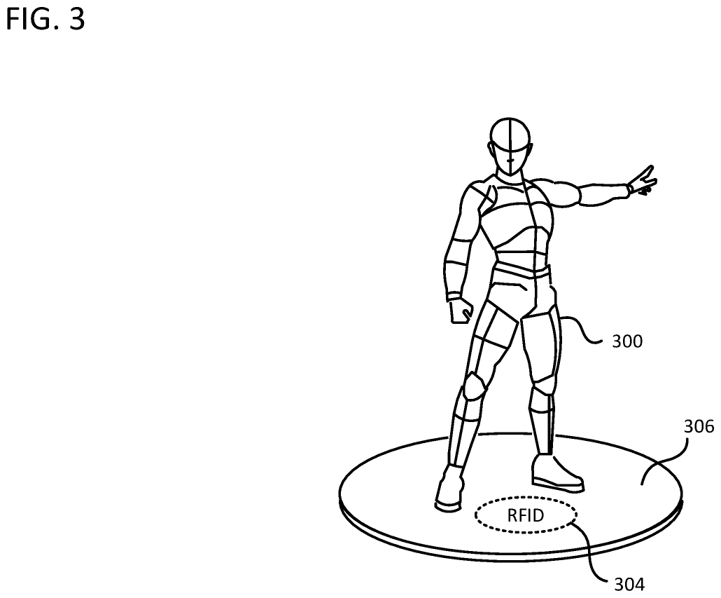

FIG. 3 shows an example of a physically manufactured character 300 based on the digital representation 242 of the user-created character. The physically manufactured character 300 includes an RFID device 304 that is contained on or within the physically manufactured character 300, for example, in a base element 306 of the physically manufactured character 300. In some embodiments, the RFID device 304 includes a module that is operable to statically store and retrieve data. For example, in some embodiments, the RFID device 304 includes a memory module (not shown) such as an EEPROM which may be accessed in accordance with ISO/IEC 14443-a and b. Such memory operations (including reading any data) can be protected using cryptographic techniques to ensure security, as are understood in the art. In some embodiments, data within the memory module may be structured such that stored data may be efficiently operated on, including providing database references for online information as well as remote and local storage for offline information. Such a memory module may be operable to be read and updated to store unique combinations of character statistics, attributes, abilities, graphical animations, and audio.

In some examples, during the manufacturing process, the RFID device 304 is embedded into or attached to the physically manufactured character 300. In these examples, this RFID device 304 is then associated (i.e., “linked”) with the digital representation of the user-created character using a smart-contract (e.g., using an ERC-721 and/or ERC-1155 smart contract standard) and referenced using a non-fungible token standard (e.g., the ERC-721 standard). In some embodiments, a memory module of the RFID device 304 advantageously acts as a “cold wallet” (i.e., offline storage) for the minted NFT, thereby advantageously bringing a new, safe, and accessible carrier to cryptocurrency, user account information, game status, game history, character status, character attributes, character history and parameters, and/or other information associated with the user and/or the user-created character. It should be noted that in practice, the principles described herein can utilize any suitable blockchain or equivalent functionality, such as Solana or Avalanche blockchains.

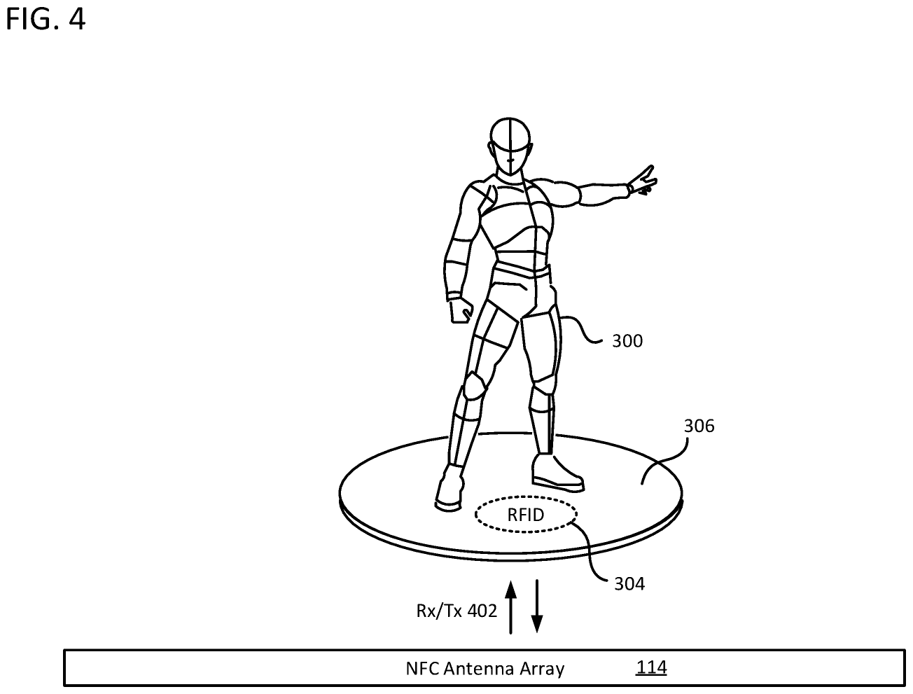

As shown in FIG. 4, upon receiving, by a user, the physically manufactured character 300, the physically manufactured character 300 is operable to interact during gameplay via an NFC enabled user device that is operable to transmit and/or receive data to/from the RFID device 304 (e.g., using the NFC antenna array 114 of the gaming device 102). In some embodiments, the user device is the gaming device 102. In other embodiments, the user device is a smartphone, a laptop computer, a desktop computer, a tablet, a gaming device, or another device that is operable to transmit and/or receive data to/from the RFID device 304 (e.g., a device having an NFC antenna built-in, or that is connected to an NFC antenna).

In some embodiments, placement of the physically manufactured character 300 on or near an NFC enabled user device (such as a gaming device or computing system) unlocks one or more features of the user device for use within a game that is presented by the user device, or that is in communication with the user device.

By using the physically manufactured character during gameplay, game and user account information is advantageously associated with the physically manufactured character 300 and with the digital representation of the user-created character. As a non-limiting example, detection of the RFID device 304 within the physically manufactured character 300 by an NFC enabled user device may advantageously place the digital representation of the user-created character in a game, may initiate a game, may initiate a module of a game, may unlock the user device, may invite a peer user of a game, may enter multiple characters in a game, may unlock a user's account for specific gameplay, and so on.

As gameplay progresses, attributes such as character level, status, or other characteristics may be associated with and/or stored by physically manufactured character 300 (e.g., either internally to the physically manufactured character 300 using a memory module in communication with the RFID device 304, on a blockchain, and/or using the user account that is linked to the physically manufactured character 300). For example, as the user-created character “levels up”, certain bonuses or attributes can be unlocked or modified and thereafter applied to the user-created character during specific gameplay. Such bonuses and attributes may be related to the type of game they are used in and may relate to that game's mechanics. Additionally, such bonuses and attributes may relate to broad abilities or traits of the user-created character such as agility, archeology, constitution, construction, cooking, crafting, defense, divination, farming, fire-making, fishing, fletching, herblore, hunting, invention, magic, melee, mining, ranging, religion, slaying, smithing, summoning, thieving, woodcutting, and many more abilities. Furthermore, the user-created character itself can be attached to digital add-on sound effects and special visual effects when the physically manufactured character is placed on, for example, the playing surface 110 of the gaming device 102, or during gameplay as visual or audible cues for a player's turn, or during specific gameplay for other reasons. In some embodiments, figurines can be used to unlock an in-game music track or other song. For example, a performing artist can release a new song that may only be unlocked using a figurine that, when placed within proximity to an entertainment system, provides a user with access to the new song.

Using the physically manufactured character 300 as a cold-wallet for the minted NFT advantageously creates an immutable and encrypted dual record of usage of the user-created character that is stored within the physically manufactured character 300 itself in addition to being stored on a blockchain. For example, in some embodiments, as gameplay continues, a record of the game and/or character attributes are recorded both using an ERC-20 token contract and is also written to the RFID device 304 of the physically manufactured character 300. In some embodiments, detection of multiple physically manufactured characters may unlock, initiate, or resume a particular game or particular game module (e.g., a particular quest, single vs. multi-player mode, a particular game, etc.).

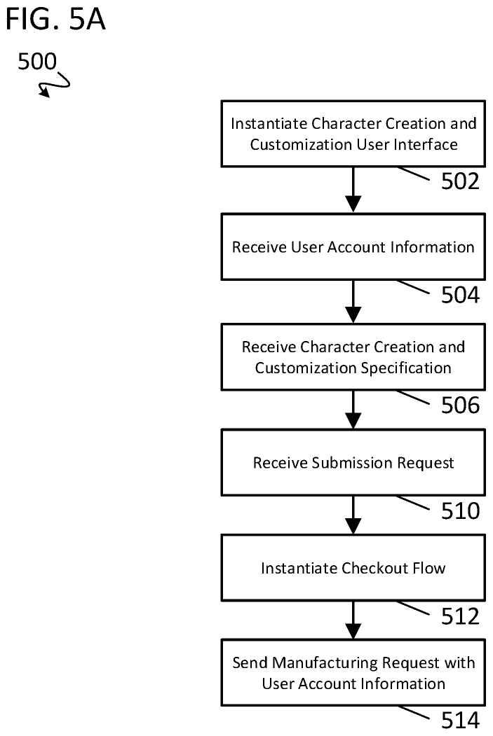

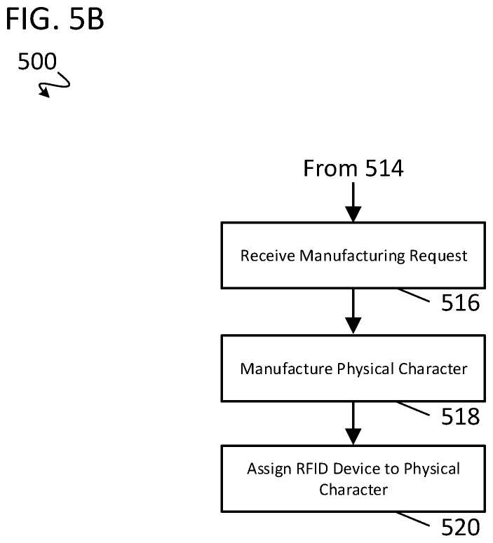

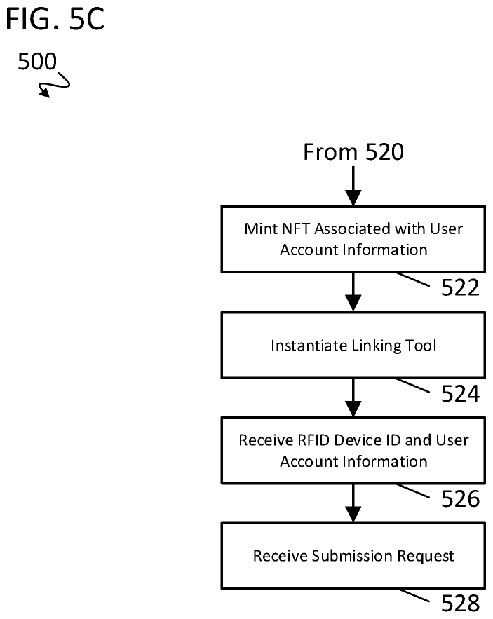

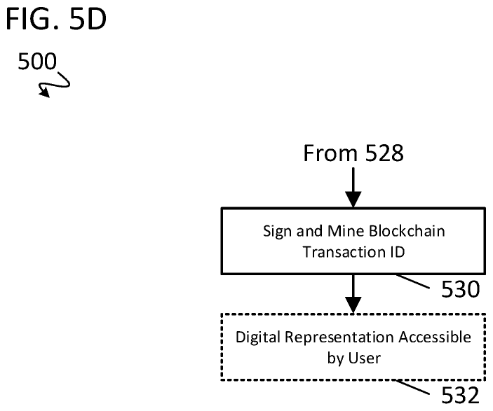

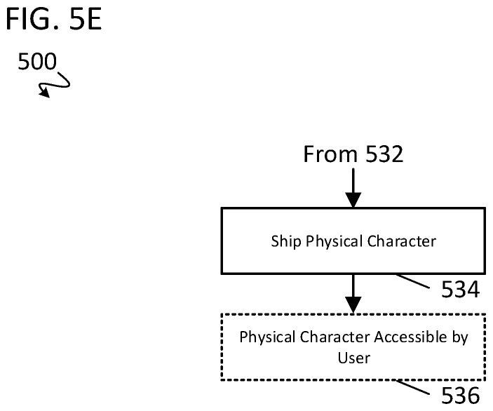

FIG. 5A through FIG. 5E illustrate example portions of a process 500 for creating RFID-enabled physically manufactured characters corresponding to customized digital characters, in accordance with some embodiments. The particular steps, the order of steps, and the combination of steps are shown for illustrative and explanatory purposes only. Other embodiments can implement different steps, orders of steps, and combinations of steps to achieve similar functions or results. The process 500 may be performed using one or more computing systems or hardware processors that may be part of the gaming device 102, such as the computing system 600 described with reference to FIG. 6 below, one or more servers, and/or one or more user devices (e.g., a smartphone, a tablet, a laptop computer, a desktop computer, etc.).

At step 502 shown in FIG. 5A, a character creation application having user interfaces similar to 240 shown in FIG. 2A and 250 in FIG. 2B is instantiated (e.g., executed) at a user device such as a laptop computer, a desktop computer, a smartphone, a tablet, the gaming device 102, etc. At step 504 user login credentials (e.g., associated with a user account) are received at the character creation application. At step 506, a character creation and customization specification for a user-created character is received at, or generated using, the character creation application (for example, via the user interface 240 shown in FIG. 2A and the user interface 250 shown in FIG. 2B). As described above, a user may specify attributes of the user-created character, for example, via the user interface 244 of the user interface 240 shown in FIG. 2A and via the user interface 254 of the user interface 250 shown in FIG. 2B.

In some embodiments, a user may purchase or import a character creation and customization specification from a third party, such as an online marketplace or forum. In some embodiments, the user may use then use the imported character creation and customization specification directly or may use the imported character creation and customization specification as a starting point for further modification. In some embodiments, the imported character creation and customization specification may already be associated with an NFT. For example, in some embodiments, artists, users, or design studios may sell, license, or auction a character creation and customization specification that is guaranteed to be authentic and/or unique via an associated minted NFT.

At step 510, a submission request is received, for example via the purchase interface 256 of the user interface 250 shown in FIG. 2B. At step 512, a checkout flow is instantiated by the character creation application (e.g., to receive user payment information, shipping details, etc.). At step 514, a manufacturing request that includes all or a portion of the character-creation and customization specification and user account information associated with the login credentials is transmitted from the character creation application directly to a manufacturer, to a remote server, to an online marketplace, or to another entity.

As shown in FIG. 5B, in some embodiments, the process 500 continues at step 516 from step 514 of FIG. 5A. At step 516, in some embodiments, the manufacturing request generated at step 514 of FIG. 5A is received at a manufacturer. In other embodiments, a manufacturing request based on the manufacturing request generated at step 514 of FIG. 5A is received at the manufacturer. At step 518, a physical character corresponding to the character creation and customization specification is physically manufactured (e.g., by 3D printing, injection molding, casting, carving, milling, etc.).

At step 520 an RFID device is assigned to the physically manufactured character. In some embodiments, the RFID device is assigned to the physically manufactured character by integrating the RFID device within the physically manufactured character (e.g., as part of a molding, casting, or 3D-printing process). In other embodiments, the RFID device is assigned to the physically manufactured character by affixing the RFID device to an outer surface of the physically manufactured character (e.g., as a label). In some embodiments, assigning the RFID device to the physically manufactured character involves writing a unique identifier (e.g., a “code”) to the RFID device, or reading a unique identifier from the RFID device if it was previously written.

As shown in FIG. 5C, in some embodiments, the process 500 continues at step 522 from step 520 of FIG. 5B. At step 522, a digital non-fungible token (NFT) associated with the digital representation of the user-created character is created (“minted”) using methods that are understood in the art. In other embodiments, an NFT that was previously associated with the character creation and customization specification is identified. At step 524, a linking tool (e.g., the user interface 260 shown in FIG. 2C) is instantiated (e.g., at a smartphone, a tablet, a laptop, a desktop computer, etc.). At step 526, the user interface 260 provides a user interface 264 that allows a user (e.g., the manufacturer) to associate the identifier stored at the RFID device with the user account information associated with the user-created character (i.e., the user account information that is, or corresponds to, the user account information that was sent to the manufacturer), and the minted NFT. At step 528, a submission request is received at the linking tool (e.g., via the interface 266) to finalize the association between the unique identifier stored at the RFID device of the physical character, the associated user account information, and the minted NFT.

As shown in FIG. 5D, in some embodiments, the process 500 continues at step 530 from step 528. At step 530, a blockchain transaction ID associated with the NFT is signed and mined, as is understood in the art. At step 532, the digital representation of the user-created character is then accessible by the user who created the character. The digital representation may include, but is not limited to, a graphical representation of the character, animations associated with the character, sounds associated with the character, attributes associated with the character, currency associated with the character, user account information, or other data.

As shown in FIG. 5E, in some embodiments, the process 500 continues at step 534 from step 532. At step 534, the physical character is shipped from the manufacturer to another party (e.g., the user who created the character, to a store, to a third-party reseller, or to another recipient). Upon receipt at step 536, the physically manufactured character is accessible by the user or other recipient.

FIG. 6 illustrates an example computing system (or “compute node”) 600 for implementing all or a portion of the methods disclosed herein, in accordance with some embodiments. In some embodiments, the computing system 600 may be a compute node of the gaming device 102. However, servers, desktop computers, laptop computers, tablets, and/or smartphones for implementing all or a portion of the process 500 may have one or more computing systems that are the same or similar to the computing system 600.

The computing system 600 generally includes one or more central processing units (CPUs) 602, a memory module 604 (e.g., RAM), a non-volatile data storage module 606 (e.g., a hard drive or array of hard drives), a network I/O module 608 (e.g., a network interface card (NIC) and/or WIFI, BLUETOOTH), and other modules 610 such as user I/O, wireless communication modules, optical communication modules, system diagnostic or monitoring modules, or other modules, one or more of the modules 602-610 being connected by one or more data busses. In some embodiments, one or more of the modules 602, 604, 606, 608, and/or 610 are coupled to the display panel 106, the first touch-sensing input device 112, the second touch-sensing input device 108, and the NFC antenna array 114 shown in FIG. 1B. The non-volatile data storage module 606 stores data and several programs for some or all of the above-described functions and process steps, among others. The data and programs are loaded into the memory module 604, so that the one or more CPUs 602 (in conjunction with the memory module 604) can perform some or all of the above-described functions and process steps, among others. In some embodiments, the CPUs 602 are shared or dedicated CPUs. These CPUs could perform a single function, perform multiple functions, or perform other tasks in addition to performing functions disclosed herein. Examples of the CPUs 602 include microprocessors, digital signal processors, microcontrollers, and dedicated hardware such as ASICs (Application Specific Integrated Circuits) and FPGAs (Field Programmable Gate Arrays).

### Additional Configuration Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, from a user, inputs defining a customized digital character comprising a physical character appearance;
generating a non-fungible token (NFT) associated with and representative of the customized digital character;
manufacturing the customized digital character to produce a figurine based on the physical character appearance, the figurine comprising a radio frequency identification (RFID) device associated with a unique identifier; and
linking, within a database, the unique identifier, the figurine, the NFT, the customized digital character, and user account information associated with the user.

2. The method of claim 1, wherein the NFT is generated based on one or more characteristics of the customized digital character.

3. The method of claim 1, wherein the NFT is further representative of the user account information.

4. The method of claim 1, wherein the NFT comprises a single-use token that can be transferred to another user, but that can be used only once to unlock one or more features associated with the figurine or the customized digital character.

5. The method of claim 1, wherein the NFT is generated based on the physical character appearance.

6. The method of claim 5, wherein the NFT is generated based on a shape, dimensions, colors, or materials defined by the physical character appearance.

7. The method of claim 5, wherein the NFT can be computed by scanning the figurine to determine characteristics of the figurine and applying an NFT-generating algorithm to the determined characteristics of the figurine.

8. The method of claim 7, wherein scanning the figurine comprises performing a 3D scan of the figurine to identify dimensions of the figurine, and wherein the NFT-generating algorithm is applied to a numerical seed value generated based on the identified dimensions of the figurine.

9. The method of claim 1, wherein a gaming system is configured to, when the figurine is placed within a proximity of the gaming system, scan the RFID device to receive the unique identifier and to unlock one or more features within the gaming system associated with the customized digital character.

10. The method of claim 9, wherein unlocking the one or more features within the gaming system comprises unlocking a character for use within a video game.

11. The method of claim 9, wherein unlocking the one or more features within the gaming system comprises unlocking one or more abilities or stats of a character within a video game.

12. The method of claim 9, wherein unlocking the one or more features within the gaming system comprises unlocking a physical appearance of a character within a video game.

13. The method of claim 9, wherein unlocking the one or more features within the gaming system comprises unlocking one or more of: a video game, a video game mode, a video game avatar, a video game item, video game currency, and a video game level or stage.

14. The method of claim 9, wherein the figurine is configured to unlock the one or more features for each of a plurality of different gaming systems when the figurine is located within a proximity of each different gaming system.

15. The method of claim 1, wherein a gaming system is configured to transmit data generated by the game system to the RFID device when the RFID device is placed within a proximity of the gaming system, and wherein the RFID device is configured to store the transmitted data.

16. The method of claim 1, wherein the figurine further comprises a non-transitory computer-readable medium.

17. The method of claim 16, wherein the non-transitory computer-readable medium is configured to store information representative of the NFT, and wherein the RFID device is configured to transmit the information representative of the NFT stored in the non-transitory computer-readable medium to a game system when the figurine is within a proximity of the game system.

18. The method of claim 16, wherein the non-transitory computer-readable medium is configured to store all or part of the user account information, and wherein the RFID device is configured to transmit all or part of the user account information stored in the non-transitory computer-readable medium to a game system when the figurine is within a proximity of the game system.

19. A non-transitory computer-readable storage medium storing executable instructions that, when executed by a hardware processor, are configured to cause the hardware processor to perform steps comprising:
receiving, from a user, inputs defining a customized digital character comprising a physical character appearance;
generating a non-fungible token (NFT) associated with and representative of the customized digital character;
coordinating the manufacture of the customized digital character to produce a figurine based on the physical character appearance, the figurine comprising a radio frequency identification (RFID) device associated with a unique identifier; and
linking, within a database, the unique identifier, the figurine, the NFT, the customized digital character, and user account information associated with the user.

20. A method comprising:
receiving, from a user, inputs defining a customized digital character comprising a physical character appearance;
generating a non-fungible token (NFT) associated with and representative of the customized digital character;
manufacturing, via a 3D printer, the customized digital character to produce a figurine based on the physical character appearance, the figurine associated with a unique identifier; and
linking, within a database, the unique identifier, the figurine, the NFT, the customized digital character, and user account information associated with the user.
